(19) United States
(12) Patent Application Publication
(10) Pub. No.: US 2005/0154703 A1
(43) Pub. Date: Jul. 14, 2005

(54) Information partitioning apparatus, information partitioning method and information partitioning program

(76) Inventor: Satoshi Ikada, Osaka (JP)

Correspondence Address: RABIN & Berdo, PC, 1101 14TH STREET, NW, SUITE 500, WASHINGTON, DC, 20005, US

(21) Appl. No.: 11/016,844

(22) Filed: Dec. 21, 2004

(30) Foreign Application Priority Data
Dec. 25, 2003 (JP) JP2003-430185

(51) Int. Cl. G06F 7/00

(52) U.S. Cl. 707/1

(57) ABSTRACT

To provide an information partitioning apparatus, an information partitioning method and an information partitioning program to be used to partition the contents of an electronic document without distinct structure information into appropriate blocks of information (document portions). According to the present invention, a reference source document describing in the form of an electronic document only superficial characteristics common among a plurality of electronic documents to undergo processing is prepared in advance. An input electronic document to undergo partition processing is compared with the reference source document, and each portion of the input electronic document which is not included in the reference source document and is only present in the input electronic document and each portion of the input electronic document which is an alteration of a portion of the reference source document are partitioned as document portions.

### CROSS REFERENCE TO RELATED APPLICATIONS

The disclosure of Japanese Patent Application No. JP2003-430185 filed Dec. 25, 2003, entitled “Information Partitioning Apparatus, Information Partitioning Method and Information Partitioning Program.” The contents of that application are incorporated herein by reference in their entirety.

### FIELD OF THE INVENTION

The present invention relates to an information partitioning apparatus, an information partitioning method and an information partitioning program used to partition an electronic document containing a plurality of blocks of information, which may be adopted to partition and sort information such as patent publications, court rulings and newsletters provided as electronic documents.

### BACKGROUND OF THE INVENTION

With the popularization of the advanced network technologies such as the Internet achieved in recent years, network users are able to access great volumes of electronic documents and technologies whereby such large volumes of document information are automatically sorted have come to constitute a vital part of electronic communication. Information provided as electronic documents include, for instance, patent publications. A patent publication is a document containing a plurality of blocks of information including the title of the invention, claims and the effect of the invention. It is necessary to partition the document in correspondence to the individual blocks of information in order to sort the different blocks of information in the document.

Japanese Patent Laid Open Publication No. 2000-285140 (Patent Literature 1) discloses an apparatus that sorts the contents of a document by partitioning it into document portions. The apparatus includes a partitioning means that partitions document data based upon structure information (HTML tags and character font information) with regard to the document data to assist the process of information sorting.

In addition, Japanese Patent Laid Open Publication No. 2001-109772 (Patent Literature 2) discloses an apparatus that extracts article portions containing keywords preregistered by a user in a document containing a plurality of articles with different contents such as an electronically distributed newsletter and sorts the document in units of the individual keywords.

However, the apparatus disclosed in Patent Literature 1 cannot be utilized effectively in conjunction with documents which, unlike patent publications, do not have distinct structure information.

The apparatus disclosed in Patent Literature 2, on the other hand, is capable of extracting a portion of a document such as a newsletter without distinct structure information as a unit article. However, newsletters include those containing articles and “advertorials” together and those in which articles are presented in units of different fields of interest such as politics, economics and sports, and there are also documents such as patent publications containing information provided under different entries, e.g., the title, the claims and the embodiments. When handling any of such documents, the apparatus disclosed in Patent Literature 2 cannot sort the document into unit articles in correspondence to the individual article categories, i.e., “article” and “advertorial” or cannot sort the document into unit articles in correspondence to the individual topics or the individual entries.

Furthermore, aside from patent publications and newsletters mentioned above, there are other diverse types of electronic documents that contain a plurality of blocks of information. It would be a complicated and time-consuming process to manually prepare or a means or a program for partitioning each of such diverse types of documents in a desirable manner.

Accordingly, the arrival of an information partitioning apparatus, an information partitioning method and an information partitioning program that allow an electronic document with no distinct structure information to be partitioned into individual blocks of information in a desirable manner has been eagerly awaited.

### SUMMARY OF THE INVENTION

In order to achieve the object described above, a first aspect of the present invention provides an information partitioning apparatus that partitions an electronic document input thereto, comprising a means for reference source document storage in which a reference source document describing in the form of an electronic document only superficial characteristics common among a plurality of electronic documents to undergo processing is stored and a means for document comparison that compares the input electronic document with the reference source document stored in the means for reference source document storage and partitions the input electronic document into document portions each constituted of a portion of the input electronic document which is not included in the reference source document and is only present in the input electronic document or a portion of the input electronic document which is an alteration of a portion in the reference source document.

A second aspect of the present invention provides an information partitioning method for partitioning an input electronic document by using a reference source document prepared in advance which describes in the form of an electronic document only superficial characteristics common among a plurality of electronic documents to undergo processing, having a document comparison step in which the input electronic document is compared with the reference source document and the input electronic document is partitioned into document portions each constituted of a portion of the input electronic document which is not included in the reference source document and is only present in the input electronic document or a portion of the input electronic document which is an alteration of a portion of the reference source document.

The information partitioning program achieved in a third aspect of the present invention is characterized in that the step executed in the information partitioning method according to the present invention achieved in the second aspect and the data that need to be prepared in advance when adopting the information partitioning method are described by using codes that can be processed on a computer.

By adopting the present invention, a reference source document is prepared in advance and an input electronic document is partitioned through comparison of the input electronic document with the reference source document. As a result, even an electronic document without distinct structure information can be partitioned into blocks of information (document portions) in a desirable manner.

### BRIEF DESCRIPTION OF THE DRAWINGS

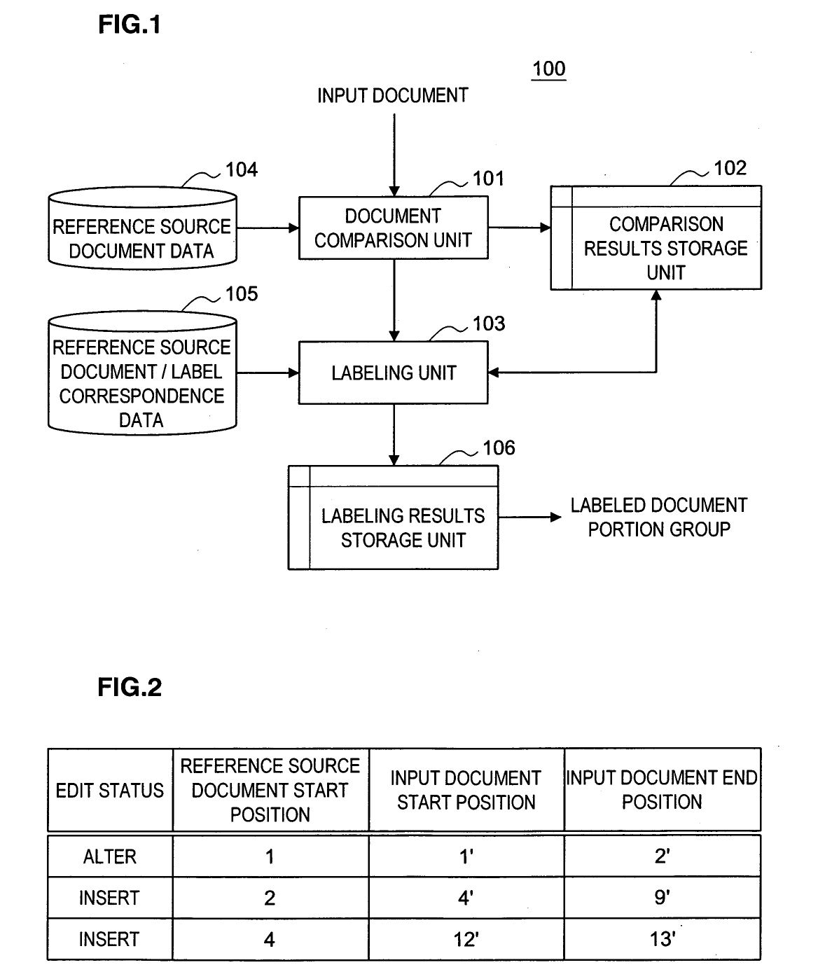

(FIG. 1) A block diagram showing the functional structure of the information partitioning apparatus achieved in a first embodiment;

(FIG. 2) An example of data stored in the comparison result storage unit in the first embodiment;

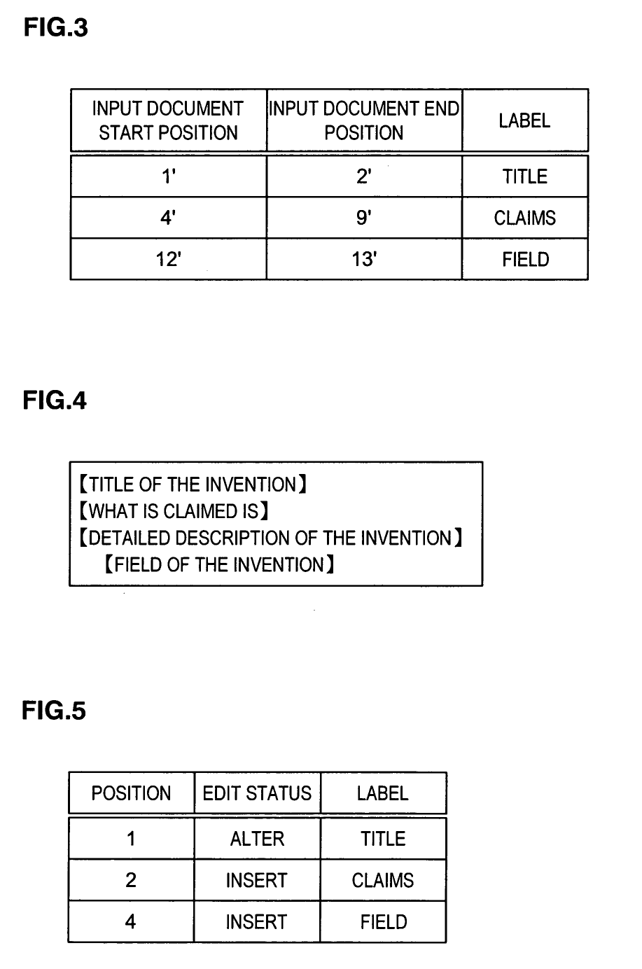

(FIG. 3) An example of labeling result data obtained in the first embodiment;

(FIG. 4) An example of a reference source document that may be used in the first embodiment;

(FIG. 5) An example of reference source document/label correspondence data used in the first embodiment;

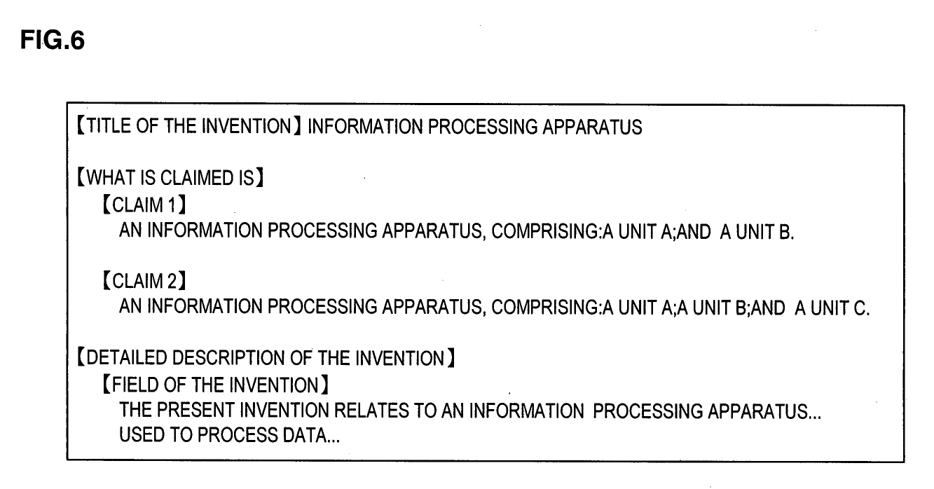

(FIG. 6) An example of an input document that may be used in the first embodiment;

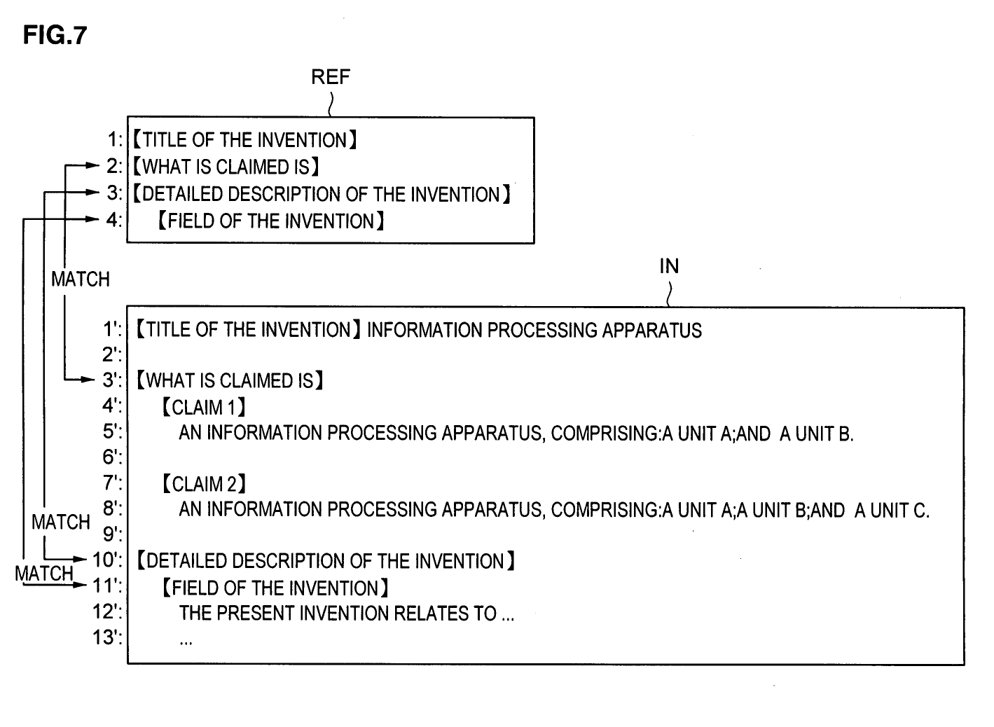

(FIG. 7) Matching lines from the reference source document in FIG. 4 and the input document in FIG. 6;

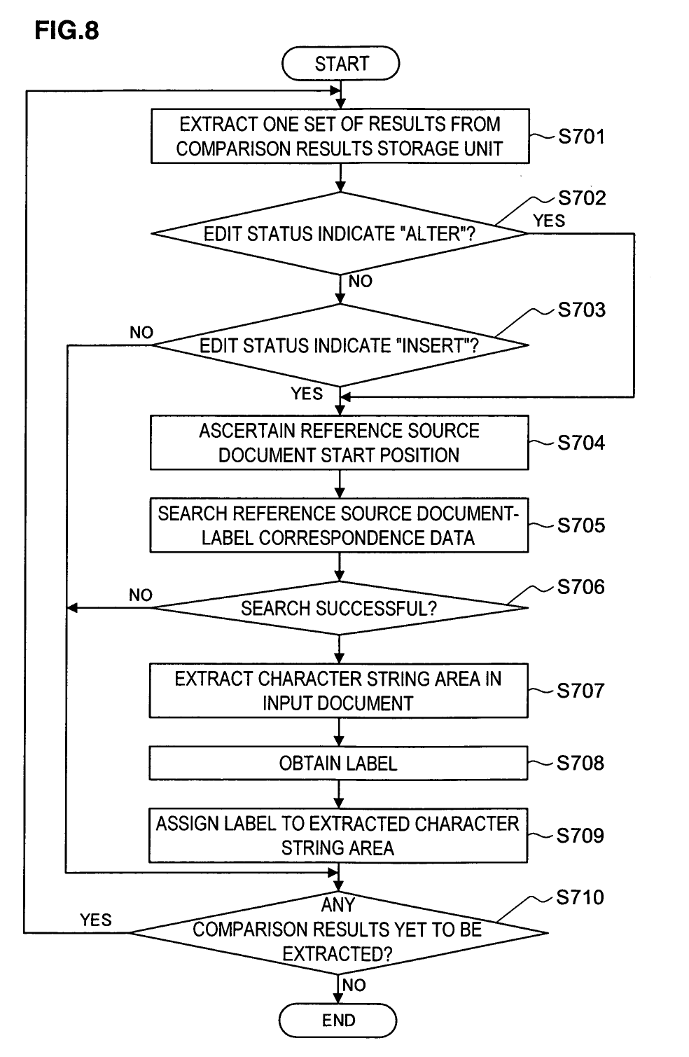

(FIG. 8) A flowchart of the labeling processing executed in the first embodiment;

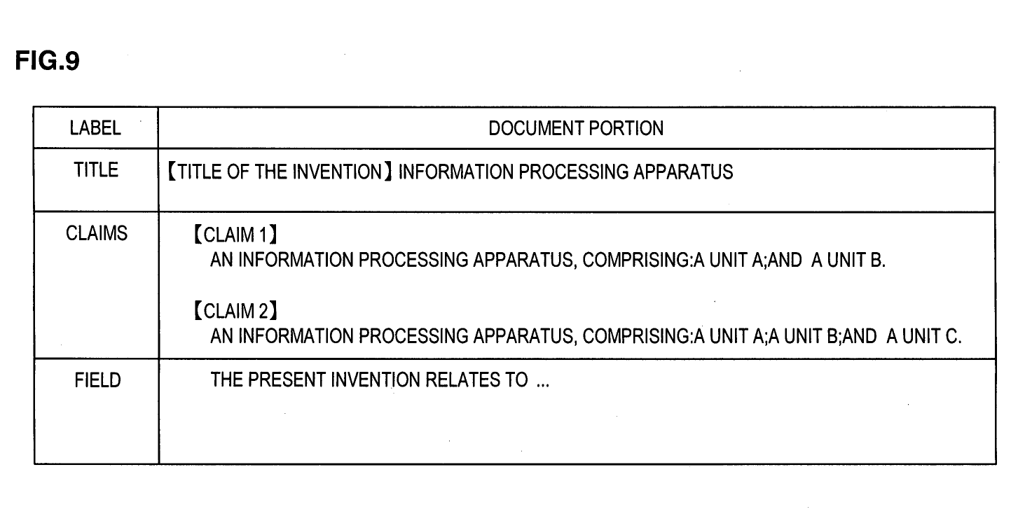

(FIG. 9) An example of a labeled document portion group obtained in the first embodiment

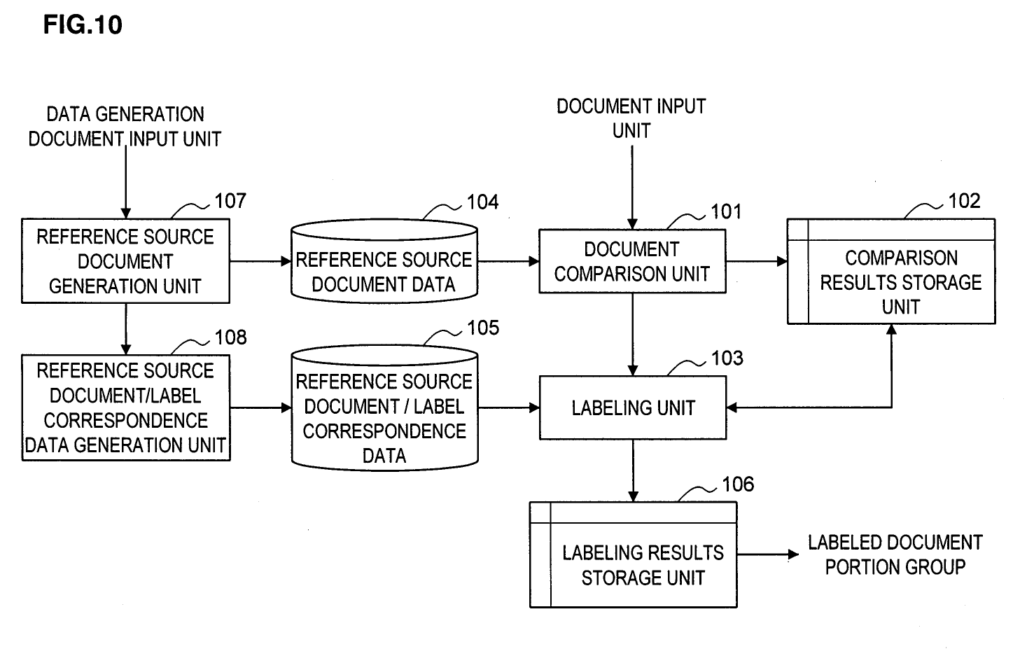

(FIG. 10) A block diagram showing the functional structure of the information partitioning apparatus achieved in a second embodiment;

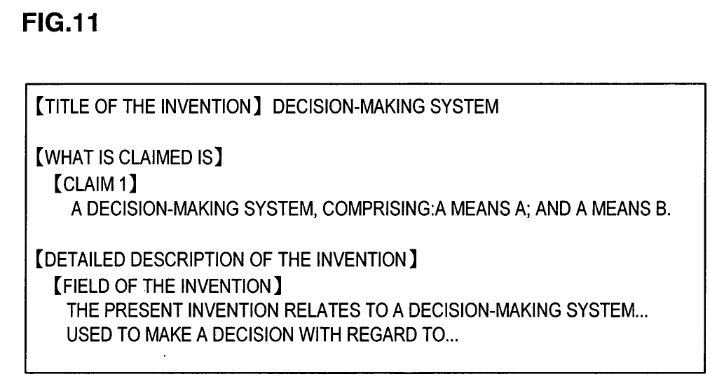

(FIG. 11) An example of a resource document that may be used to generate a reference source document in the second embodiment;

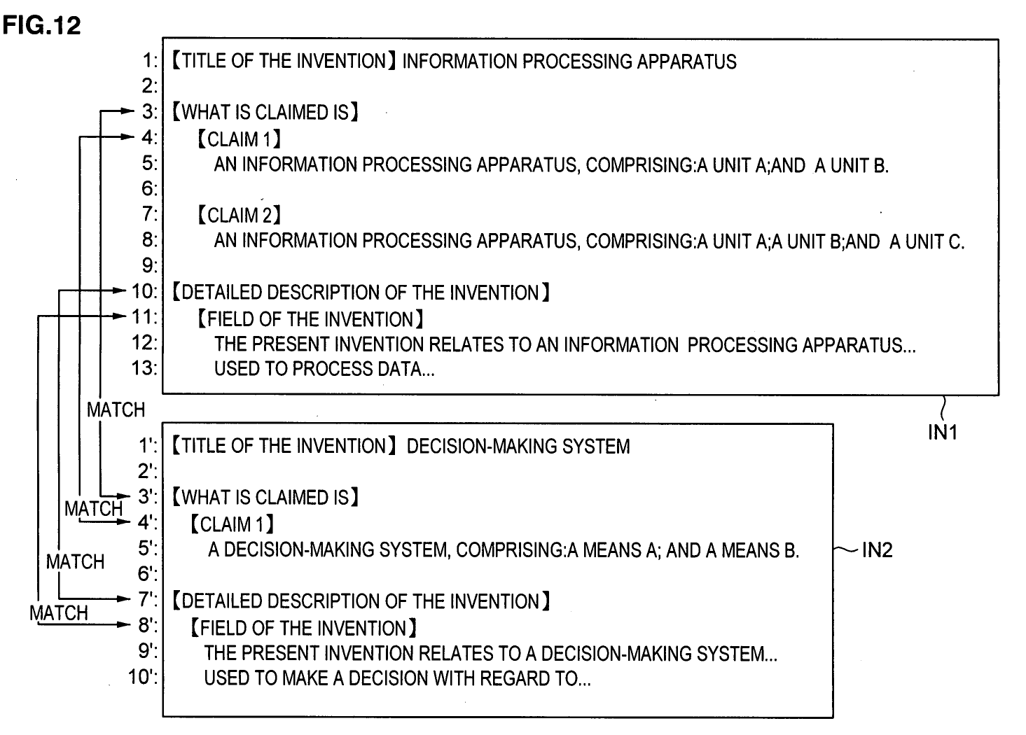

(FIG. 12) Matching lines from two resource documents used to generate a reference source document in the second embodiment;

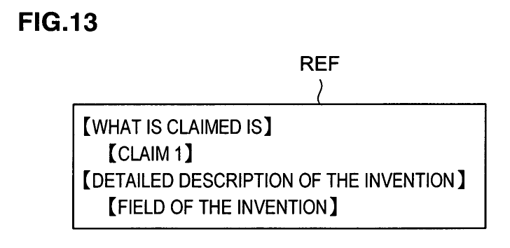

(FIG. 13) An example of a reference source document that may be generated in the second embodiment;

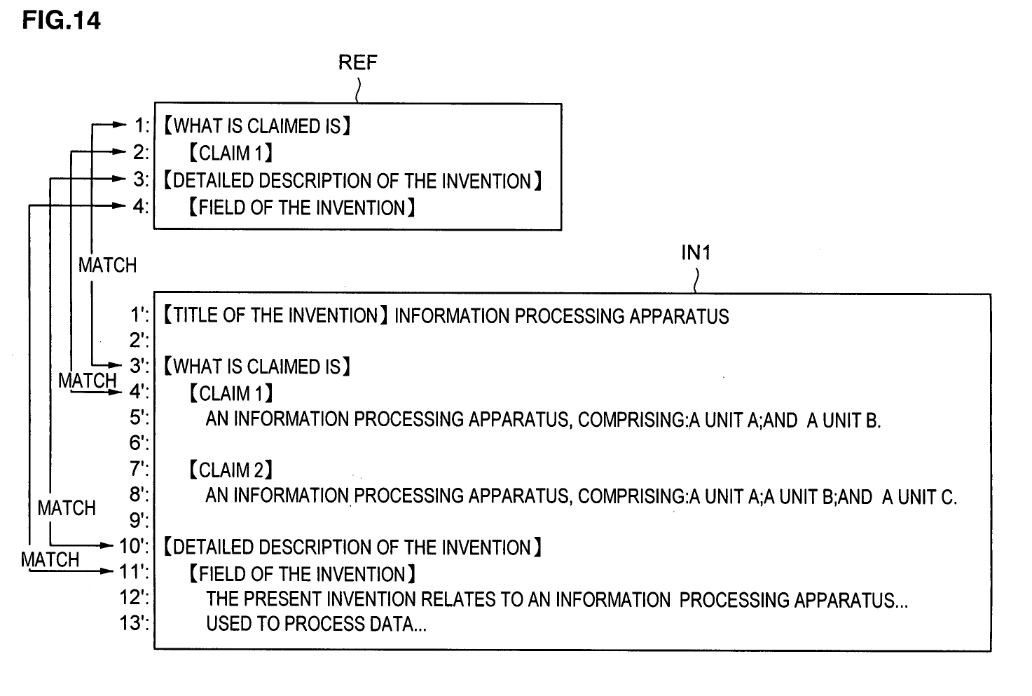

(FIG. 14) An example of the results of correlation processing executed to correlate the reference source document and a resource document when generating reference source document/label correspondence data in the second embodiment;

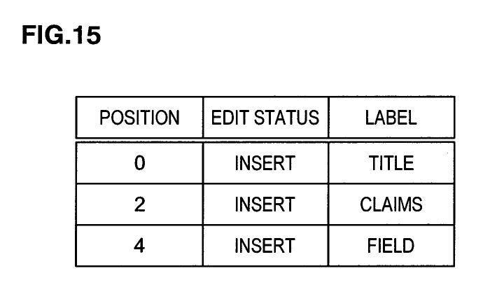

(FIG. 15) An example of reference source document/label correspondence data generated in the second embodiment.

### DETAILED DESCRIPTION OF THE PREFERRED EMBODIMENTS

### (A) First Embodiment

The following is a detailed explanation of the information partitioning apparatus, the information partitioning method and the information partitioning program achieved in the first embodiment of the present invention, given in reference to the drawings.

### (A-1) Structure of the First Embodiment

FIG. 1 is a block diagram showing the functional structure of the information partitioning apparatus achieved in the first embodiment. The functions of the information partitioning apparatus in the first embodiment, which may be achieved by, for instance, installing an information partitioning program (including a data file, a table having stored therein data and the like) that is recorded in a recording medium such as a CD-ROM or a flexible disk into an information processing apparatus having a communication function, e.g., a computer or by downloading such an information partitioning program from a network and installing the downloaded program in the information processing apparatus, are provided as shown in FIG. 1.

An information partitioning apparatus 100 in the first embodiment shown in FIG. 1 includes a document comparison unit 101, a comparison result storage unit 102, a labeling unit 103, reference source document data 104, reference source document/label correspondence data 105 and a labeling result storage unit 106.

The document comparison unit 101 compares an input document with a reference source document which is to be described later and detects an edit status indicating an increase/decrease or an alteration manifesting between data in the reference source document and data in the input document and the corresponding data areas (both in the reference source document and in the input document). The document comparison unit 101 may be achieved by adopting, for instance, the method disclosed in reference literature “E. Myers, “An O (ND) (Difference Algorithm and Its Variations”, Algorithmica 1, 2 (1986), pp. 251-266”.

The edit status indicates the comparison results obtained at the document comparison unit 101 as described above, which are classified as “match”, “alter”, “insert” or “delete”. The document comparison unit 101 indicates “match” when it detects identical expressions at a given position i in the reference source document and at a given position j in the input document. The document comparison unit 101 indicates “alter” when it detects a given area (a range from a given position i to another position i+n (n≧0)) in the reference source document replaced with a given area (ranging from a given position j to another position j+m (m≧0)) in the input document. “insert” is indicated when the document comparison unit 101 detects that the input document includes a character string inserted between a given position i and a given position i+1 in the reference source document. “delete” is indicated when the document comparison unit 101 detects that a given area (ranging from a given position i to another position i+n (n≧0)) in the reference source document is deleted from the input document.

The comparison result storage unit 102 stores in memory the results of the comparison executed by the document comparison unit 101. The comparison result storage unit 102 stores in memory data indicating a reference source document edit start position, an input document edit start position and an input document edit end position in correspondence to each detected edit status, as shown in FIG. 2, for instance.

The labeling unit 103 assigns sorting labels to individual areas in the input document by using the data stored in the comparison result storage unit 102 and data contained in the reference source document/label correspondence data 105, which are to be detailed later.

The labeling result storage unit 106 stores in memory the results of the processing (the labeling results) executed by the labeling unit 103. The labeling result data recorded in the labeling result storage unit 106 may be data indicating input document start positions, input document end positions and labels, which are stored separately from the input document, such as those shown in FIG. 3, or may adopt a mode which allows the data to be directly output, such as the data shown in FIG. 9 to be detailed later.

The reference source document data 104 constitute a reference source document (reference source document data) input to the document comparison unit 101. It is to be noted that the term “reference source document data” may be used to refer to the data themselves or to the storage area where the data are stored in this specification. The reference source document, which is used to extract portions of the input document to be sorted (hereafter referred to as document portions), contains character strings in lines constituting, for instance, break points between document portions in units of individual lines by maintaining the original arrangement of the lines. FIG. 4 shows an example of a reference source document that is intended for use when the input document is a patent specification.

The reference source document/label correspondence data 105 indicates positions in the reference source document, edit statuses ascertained as the comparison results and labels, as shown in FIG. 5, for instance. It is to be noted that in this specification, the term “reference source document/label correspondence data” may be used to refer to the data themselves or to the storage area where the data are stored.

### (A-2) Operation Executed in the First Embodiment

Next, the operation executed (the information partitioning method adopted) in the information partitioning apparatus 100 in the first embodiment having the structure described above is explained. It is to be noted that the following explanation is given on a specific example in which the document (data) shown in FIG. 6 is input in the information partitioning apparatus 100 having stored in advance the reference source document (data) in FIG. 4 and the reference source document/label correspondence data shown in FIG. 5.

It is to be noted that the document may be input through a document input unit (not shown) by adopting any input method. For instance, document data downloaded via a network from a provider, either free of charge or for a fee, may be input. Alternatively, document data may be read out from a recording medium such as a flexible disk or a CD-ROM and the document data thus read out may be input. In addition, a document may be entered through a keyboard or a paper document may be converted to an electronic document through OCR (optical character reader) and then may be input. Moreover, an e-mail may be directly input or an e-mail taken in from a mail server may be input. In such a case, the main text portion alone may be input by first slicing out the main text portion.

The document input through the document input unit is then transferred to the document comparison unit 101 as character string data. The document comparison unit 101 executes a comparison of the input document with the reference source document and detects differences between the two documents. The document comparison unit 101 adopting, for instance, the document comparison method disclosed in the reference literature mentioned above detects the differences between the two documents by extracting in sequence the document data in the reference source document and the input document in units of the individual lines, comparing the individual lines to ascertain whether or not they contain identical character strings and looking for matching lines so as to minimize the number of unmatched lines.

FIG. 7 shows the results of the comparison of the reference source document REF shown in FIG. 4 and the input document IN shown in FIG. 6.

In FIG. 7, the numerals on the left side each indicate a specific position, which are provided to facilitate the explanation. It is to be noted that the processing is executed on the reference source document REF and the input document IN both containing information used to specify positions (line positions) in the documents. Namely, if the input document initially does not contain such information, the document comparison unit 101 first executes processing for adding position information.

By minimizing the number of lines that are left unmatched, the document comparison unit 101 detects the line at position 2 in the reference source document REF and the line at position 3′ in the input document IN, the line at position 3 in the reference source document REF and the line at position 10′ in the input document IN, and the line at position 4 in the reference source document REF and the position 11′ in the input document IN as sets of matching lines. It is to be noted that the line at position 0 immediately preceding the first line in the reference source document REF and the line at position 0′ immediately preceding the first line in the input document IN (a hypothetical combination that does not exist) and the line at position 5 immediately following the last line in the reference source document REF and the line at position 14′ immediately following the last line in the input document IN (a hypothetical combination that does not exist) are both regarded as sets with matching lines.

After detecting the matching lines in the reference source document REF and the input document IN as described above, the document comparison unit 101 generates (data indicating) the comparison results to be stored into the comparison result storage unit 102. The comparison result data in FIG. 2 explained earlier are data stored in the comparison result storage unit 102 when the reference source document REF and input document IN achieve correspondence as shown in FIG. 6.

It is to be noted that the result data stored in the comparison result storage unit 102 may indicate all the types of edit statuses, i.e., “match”, “alter”, “insert” and “delete”, may indicate three different types of edit statuses, i.e., “alter”, “insert” and “delete” or may indicate two different types of edit statuses, “alter” and “insert”. Namely, while document portions can be sorted and extracted as long as at least the two edit statuses, i.e., “alter” and “insert”, can be recognized, faster processing may be achieved depending upon the specific structure of the comparison result storage unit 102 if “match”, “alter”, “insert” and “delete” or “alter”, “insert” and “delete” output from the document comparison unit are directly stored without first sifting the output. FIG. 2 shows result data stored in the comparison result storage unit 102, which indicate only two types of edit statuses, “alter” and “insert”.

Between the two successive matched lines in the reference source document REF, i.e., between the line at position 0 and the line at position 2, a line at position 1 is present, whereas there are two lines present between the corresponding pair of matched lines at position 0′ and position 3′ in the input document IN. These two lines do not match the line at position 1 in the reference source document and, accordingly, the edit status “alter”, the reference source document edit start position “1” “the input document edit start position ” 1′” and the input document edit end position “2′” are stored as the first set of records in the comparison results data.

There is no line between the next two matched lines at position 2 and position 3 in the reference source document REF, whereas there are six lines present between the corresponding matched lines in the input document IN, i.e., between the lines at position 3′ and the line at position 10′. Accordingly, the edit status “insert”, the reference source document edit start position “2”, the input document edit start position “4′” and the input document edit end position “9′” are stored as the next set of records in the comparison results data.

In addition, since there is no line present between the next two matched lines at positions 3 and 4 in the reference source document REF, and also, there is no line present between the corresponding matched lines in the input document IN, i.e., between the line at position 10′ and the line at position 11′. Since the edit status is not either “insert” or “alter”, the data corresponding to the results of this particular comparison are not stored into the comparison result storage unit 102.

The third set of records in FIG. 2 is generated and stored based upon the same principle as that which applies to the second set of records in FIG. 2.

Next, the labeling unit 103 assigns labels by using the reference source document/label correspondence data 105 and the data at the comparison result storage unit 102. FIG. 8 presents a flowchart of the label assigning operation executed by the labeling unit 103.

The labeling unit 103 extracts a set of the result data (a set of records) in the comparison result storage unit 102 (S701) and makes a decision as to whether or not the edit status in the extracted result data indicate “alter” or “insert” (S702, S703).

If it is judged that the edit status in the extracted result data does not indicate either “alter” or “insert” (in other words, if the edit status is “delete” or “match”), the labeling unit 103 makes a decision as to whether or not there are result data yet to be processed (S710), and the operation returns to step S701 to extract another set of result data if it is judged that there are still unprocessed results data, whereas the sequence of processing in FIG. 8 ends if there are no more unprocessed result data remaining. It is to be noted that if the data stored in the comparison result storage unit 102 indicate only two types of statuses “alter” and “insert”, a decision is made as to whether the edit status indicates “alter” or “insert”.

If the edit status is judged to indicate “insert” or “alter”, the reference source document start position in the same set of result data is ascertained (S704). Then, by using the combination of the edit status and the reference source document start position as a key, the reference source document/label correspondence data 105 are searched to find the corresponding set of records (S705, S706). In other words, a set of records indicating a position matching the reference source start position and an edit status matching the detected edit status is found in the reference source document/label correspondence data 105.

Once the search is executed successfully, the corresponding character string area (document portion) in the input document is extracted (S707) based upon the input document edit start position and the input document edit end position in the results data, ascertains the value (label) stored in the label field in the records searched from the reference source document/label correspondence data 105 (S708), the label thus obtained is attached to the extracted character string area (document portion) and the labeled document portion is stored into the labeling result storage unit 106 (S709). The data stored into the labeling result storage unit 106 may be the type of data such as that shown in FIG. 3 that allows the generation of an output document (see FIG. 9) by using the input document in response to an output requests, or they may be the type of data that can be directly output in response to an output request, as shown in FIG. 9. It is to be noted that if the data adopt the former mode, processing for extracting the input document edit start position and the input document edit end position in the result data is executed in step S707.

The processing described above (in steps S701 through S709) is repeatedly executed until there are no more comparison result data that can be processed (S710), and once the comparison result data have all been processed, the sequence of processing in FIG. 8 ends.

For instance, if the first set of comparison result data in FIG. 2 indicating the edit status “alter” and the reference source document start position “1” is extracted in step S701, the first set of records in the reference source document/label correspondence data 105 in FIG. 5 is judged to be the match through the search, the label “title” in the set of records is extracted and the label “title” is attached to the portion (document portion) present in the range between position 1′ and position 2′ in the input document.

Since there are other sets of result data yet to be processed at this point, the second set of result data in FIG. 2 is then extracted. These result data indicate the edit status “insert” and the reference source document start position “2”. Thus, it is judged that the second set of records in the reference source document/label correspondence data 105 in FIG. 5 is the match through the search, the label “claims” contained in the set of records is extracted and the label “claims” is attached to the portion (document portion) present in the range between position 4′ and position 9′ in the input document.

Since there is another set of result data yet to be processed at this point, the third set of result data in FIG. 2 is then extracted. These result data indicate the edit status “insert” and the reference source document start position “4”. Thus, it is judged that the third set of records in the reference source document/label correspondence data 105 in FIG. 5 is the match through the search, the label “field” contained in the set of records is extracted and the label “field” is attached to the portion (document portion) present in the range between position 12′ and position 13′ in the input document.

When data are stored in the labeling result storage unit 106 in the data format shown in FIG. 3, the output data shown in FIG. 9 may be generated by using the stored data and the input document, as explained below.

For instance, based upon the first set of data in FIG. 3, the character string data from the line 1′ through the line 2′ in the input document, i.e., “(Title of the Invention) Information Processing Apparatus” (the bold parentheses in the figure are replaced with regular parentheses) are extracted as a document portion and the label “title” in the first set of data in FIG. 3 is attached to the extracted document portion. Similar processing is executed for the second and third sets of data in FIG. 3.

The group of labeled document portions, such as that shown in FIG. 9, is output as necessary through a document output unit (not shown). For instance, the document output unit may output the labeled document portion group as a screen display, may print it out, may output it by recording it into a recording medium or may output it by transferring it to another apparatus.

It is to be noted that no restriction is imposed with regard to the method of output, and the user may be allowed to specify a given label to output the document portion corresponding to the specified label alone, instead of having all the document portions output.

### (A-3) Advantages on the First Embodiment

As described above, the first embodiment achieves advantages in that a character string area (document portion) corresponding to a specific type of information can be recognized and extracted from a processing target document which may not always have a distinct structure in compliance with XML, HTML or SGML, simply by preparing a reference source document describing superficial characteristics (character strings or horizontal lines indicating various entries, character strings or horizontal lines present at break points of different entries etc.) that often appear in documents to be sorted.

It also achieves an advantage in that by using the labeling data prepared in correspondence to the reference source document, a label can be assigned to a character string area (document portion) that has been recognized or extracted.

### (B) Second Embodiment

Next, the information partitioning apparatus, the information partitioning method and the information partitioning program achieved in the second embodiment of the present invention are described in detail in reference to drawings.

### (B-1) Structure of the Second Embodiment

FIG. 10 is a block diagram showing the functional structure of an information partitioning apparatus 10A achieved in the second embodiment, with the same reference numerals assigned to components corresponding to those in FIG. 1 in reference to which the first embodiment has been explained.

In addition to the components of the information partitioning apparatus 10 in the first embodiment, the information partitioning apparatus 10A achieved in the second embodiment includes a reference source document data generation unit 107 and a reference source document/label correspondence data generation unit 108. Since components other than these have functions identical to those in the first embodiment, their explanation is omitted.

The reference source document data generation unit 107 generates a reference source document 104 based upon two documents (document data) input thereto and stores the generated reference source document in its storage unit. The specific method adopted to generate the reference source document 104 is to be explained later in reference to the operation of the information partitioning apparatus.

The reference source document/label correspondence data generation unit 108 generates the reference source document/label correspondence data 105 to be used at the labeling unit 103 and stores the generated reference source document/label correspondence data in its storage unit. The specific method adopted to generate the reference source document/label correspondence data 105 is to be described later in reference to the operation of the information partitioning apparatus.

### (B-2) Operation Executed in the Second Embodiment

The individual operations executed at the reference source document data generation unit 107 and the reference source document/label correspondence data generation unit 108 differentiate the information partitioning apparatus in the second embodiment from the information partitioning apparatus in the first embodiment, and accordingly, the following explanation focuses on the operations executed at the reference source document data generation unit 107 and the reference source document/label correspondence data generation unit 108.

Two different documents (document data) having similar superficial characteristics are input to the reference source document data generation unit 107 through a data resource document input unit (no reference numeral assigned). For instance, the document shown in FIG. 4 and the document shown in FIG. 11, both described earlier, may be input.

At the reference source document data generation unit 107, the two documents having been input are first compared with each other. The documents may be compared through a method similar to that adopted in the means for document comparison 101 explained in reference to the first embodiment. If the document comparison execution unit is mainly constituted in software, its processing routine may be used by both the means for document comparison 101 and the reference source document data generation unit 107.

FIG. 12 shows lines in the two documents IN1 and IN2 judged to achieve matches based upon the results of the comparison. The reference source document data generation unit 107 outputs only the lines judged to achieve matches, as shown in FIG. 12, in the order they appear as a reference source document 104 and stores (registers) the output reference source document in its storage unit. FIG. 13 shows the reference source document generated based upon the results of the comparison shown in FIG. 12. It is to be noted that the reference source document data generation unit 107 excludes blank lines in the two documents IN1 and IN2 in which no characters (character data) are present from the match decision-making process.

Once the processing executed by the reference source document data generation unit 107 is completed, processing by the reference source document/label correspondence data generation unit 108 starts. The reference source document/label correspondence data generation unit 108 works in collaboration with the user to generate the reference source document/label correspondence data.

The reference source document/label correspondence data generation unit 108 first correlates portions of the reference source document generated by the reference source document data generation unit 108 to portions of a document (preferably a document used as a resource when generating the reference source document) used for the generation of the reference source document/label correspondence data. Namely, it recognizes the lines in the resource document corresponding to the specific lines in the reference source document.

FIG. 14 shows the correspondence between the reference source document REF in FIG. 13 and one of the documents used as the resource for the generation of the reference source document i.e., IN1. It is to be noted that in addition to the corresponding lines shown in FIG. 14, the reference source document/label correspondence data generation unit 108 regards position 0 preceding position 1 in the reference source document REF and position 0′ preceding position 1′ in the document IN1 as positions corresponding with each other and regards position 5 following the last position 4 in the reference source document REF and position 14′ following the last position 13′ in the document IN as positions corresponding with each other.

Next, the reference source document/label correspondence data generation unit 108 recognizes portions with edit statuses that can be judged to indicate “insert” or “alter” on the premise that the corresponding relationship described above indicates matching lines (through processing similar to the processing executed by the means for document comparison 101), and determines values to indicate the “reference source document start positions” and “edit statuses” in the reference source document/label correspondence data. At this point, the data do not include any values corresponding to the labels in FIG. 15.

In order to determine the value (label name) to indicate the label for the first set of records in FIG. 15, the reference source document/label correspondence data generation unit 108 brings up a display of the area (the two lines at positions 1′ and 2′) corresponding to the edit status “insert” in the document IN1 together with a message prompting the user to enter the name of the label to be assigned to this area, and then takes in the value (label name) indicating the label name entered by the user in response. The user is also prompted to enter the label values (label names) for the second and third sets of records in FIG. 15.

The reference source document/label correspondence data generation unit 108 subsequently outputs the complete reference source document/label correspondence data generated as described above as the reference source document/label correspondence data 105 and stores (registers) them in its storage unit.

FIG. 15 shows the reference source document/label correspondence data 105 having been generated as described above in the complete form. Values indicating the specific label names “title” “claims” and “field” in FIG. 15 are selected and entered by the user.

### (B-3) Advantage of the Second Embodiment

In addition to the advantages of the first embodiment, the second embodiment achieves an advantage in that a reference source document can be automatically generated. Once a given reference source document and reference source document/label correspondence data are prepared, a document subsequently input can be sorted by using these data.

### (C) Other Embodiments

While two documents are compared with each other by the document comparison unit 101 and the reference source document generation unit 107 in units of individual lines in the embodiments described above, the two documents may instead be compared in units of individual characters, or in units of individual words after executing morphological analysis processing. As a further alternative, the two documents may be compared through a combination of character-based comparison and word-based comparison.

In addition, while an input document is first partitioned into document portions and then labels are assigned to the individual document portions in the embodiments explained above, the document partitioning apparatus may simply partition the input document into document portions instead.

Furthermore, while an explanation is given above on the embodiments in reference to a single reference source document, a plurality of reference source documents of different types such as a reference source document to be used in conjunction with patent specifications, a reference source document to be used in conjunction with patent applications, a reference source document to be used in conjunction with newsletters and a reference source document to be used in conjunction with court rulings may be provided and, in such a case, a plurality of sets of reference source document/label correspondence data should be provided in correspondence. For instance, before inputting the document to be sorted, the user may specify the reference source document to be used to the apparatus, or the input document may be compared with all the reference source documents and then the subsequent processing may be executed by using the reference source document with the greatest number of matching lines as a valid reference source document. Alternatively, the reference source document may be automatically selected by ascertaining whether or not a given document contains character strings or character string patterns (e.g., a newsletter title) inherent to a specific type of document (patent specification, newsletter or court ruling).

While two documents are input to the reference source document generation unit 107 in the second embodiment, three or more different documents may instead be input, and in such a case, the reference source document may be created by including the lines that are commonly present in all the documents, or by including matching lines found in a predetermined number of documents (e.g., in the majority of documents).

In addition, while the apparatus automatically determines the “positions” and the “edit statuses” in the reference source document/label correspondence data and “labels” are entered by the user in the second embodiment, reference source document/label correspondence data may be generated by adopting another method. For instance, the “positions”, the “edit statuses” and the “labels” may all be entered by the user or the “positions”, the “edit statuses” and the “labels” may all be automatically determined by the apparatus. The label values may each be constituted with the entire character string in the first line of the document portion corresponding to a given edit status in the resource document or a character string enclosed within parentheses in the first line.

1. An information partitioning apparatus that partitions an electronic document input thereto, comprising:
a means for reference source document storage in which a reference source document describing in the form of an electronic document only superficial characteristics common among a plurality of electronic documents to undergo processing is stored; and
a means for document comparison that compares said input electronic document with said reference source document stored in said means for reference source document storage and partitions a portion of said input electronic document into document portions each constituted of a portion of said input electronic document which is not included in said reference source document and is only present in said input electronic document or a portion of said input electronic document that is an alteration of a portion of said reference source document.

2. An information partitioning apparatus according to claim 1, further comprising:
a means for reference source document/label correspondence data storage in which a plurality of sets of data, each indicating a position in said reference source document, an edit status among at least four edit statuses, “match”, “alter”, “insert” and “delete” and a label are stored; and
a labeling means that searches said means for reference source document/label correspondence data storage by using the edit status of each document portion and the position in said reference source document corresponding to said document portion as a key and assigns labels to individual document portions detected by said means for document comparison.

3. An information partitioning apparatus according to claim 1, further comprising:
a means for reference source document generation that compares a plurality of different electronic documents and generates said reference source document by extracting superficial characteristics common in said plurality of electronic documents.

4. An information partitioning apparatus according to claim 3, further comprising:
a means for reference source document/label correspondence data generation that generates reference source document/label correspondence data corresponding to said reference source document having been generated, based upon a correlation between said reference source document generated by said means for reference source document generation and an electronic document used as a resource when generating said reference source document.

5. An information partitioning apparatus according to claim 2, further comprising:
a means for reference source document generation that compares a plurality of different electronic documents and generates said reference source document by extracting superficial characteristics common in said plurality of electronic documents.

6. An information partitioning apparatus according to claim 5, further comprising:
a means for reference source document/label correspondence data generation that generates reference source document/label correspondence data corresponding to said reference source document having been generated, based upon a correlation between said reference source document generated by said means for reference source document generation and an electronic document used as a resource when generating said reference source document.

7. An information partitioning method for partitioning an electronic document having been input, by using a reference source document prepared in advance, which describes in the form of an electronic document only superficial characteristics common among a plurality of electronic documents to undergo processing, which includes;
a document comparison step in which said input electronic document is compared with said reference source document and said input electronic document is partitioned into document portions each constituted of a portion of said input electronic document which is not included in said reference source document and is present only in said input electronic document or a portion of said input electronic document which is an alteration of a portion of said reference source document are partitioned.

8. An information partitioning method according to claim 7, for partitioning an electronic document having been input by using a plurality of sets of reference source document/label correspondence data each indicating a position in said reference source document, an edit status among at least four edit statuses, “match”, “alter”, “insert” and “delete” and a label, which further includes;
a labeling step in which labels are attached to individual document portions detected in said document comparison step by searching for reference source document/label correspondence data matching the edit status of each document portion and the position in said reference source document corresponding to said document portion.

9. An information partitioning method according to claim 7, further including:
a reference source document generation step in which said reference source document is generated by comparing a plurality of different electronic documents and extracting superficial characteristics common among said plurality of electronic documents.

10. An information partitioning method according to claim 9, further including:
a reference source document/label correspondence data generation step in which reference source document/label correspondence data corresponding to said reference source document having been generated are generated based upon a correlation between said reference source document generated in said reference source document generation step and an electronic document used as a resource when generating said reference source document.

11. An information partitioning method according to claim 8, further including:
a reference source document generation step in which said reference source document is generated by comparing a plurality of different electronic documents and extracting superficial characteristics common among said plurality of electronic documents.

12. An information partitioning method according to claim 11, further including:
a reference source document/label correspondence data generation step in which reference source document/label correspondence data corresponding to said reference source document having been generated are generated based upon a correlation between said reference source document generated in said reference source document generation step and an electronic document used as a resource when generating said reference source document.

13. An information partitioning program describing the step executed in an information partitioning method according to claim 7 and data prepared in advance to implement the information partitioning method by using codes that can be processed on a computer.
